(19) United States
(12) Patent Application Publication
(10) Pub. No.: US 2016/0154018 A1
(43) Pub. Date: Jun. 2, 2016

(54) SYSTEM FOR THE ANALYSIS OF SAMPLES

(71) Applicant: AXA DIAGNOSTICS S.R.L ., Milano (IT)

(72) Inventor: Lorenzo BALLI, Signa (IT)

(73) Assignee: AXA DIAGNOSTICS S.R.L., Milano (IT)

(21) Appl. No.: 15/015,164

(22) Filed: Feb. 4, 2016

Related U.S. Application Data
(63) Continuation-in-part of application No. 13/812,524, filed on Jan. 28, 2013.

(30) Foreign Application Priority Data
Jul. 27, 2010 (IT) BO2010A000475

(51) Int. Cl. G01N 35/02; G01N 35/00; G01N 35/10

(52) U.S. Cl. CPC G01N 35/026; G01N 35/10; G01N 35/1083; G01N 35/00584; G01N 2035/103

(57) ABSTRACT

The invention relatges to a system for the analysis of samples of the type comprising a work surface (10) on which are arranged a number of racks (4) to support tubes or containers, characterized in that the work surface (10) is realized by means of a plurality of parallel guides (11) having a cross section which is complementarily matchable with a corresponding seat (44) of said rack (4), said seat (44) of said racks (4) having a width which is multiple of the value of the section of said guide (11) and having opposing portions (410) which are corresponding to the profile of the guides (11).

The present invention relates to a system for the analysis of samples.

In particular, the system can be used for the analysis of biological samples with the application in the diagnostic field.

In the analysis of biological samples, for which it is necessary that the samples react with appropriate reagents, the analysis process is now almost fully automated. In fact, the known apparatuses can pick up automatically or semi-automatically, and in succession, a series of samples; each sample to be analyzed (which is contained in a test tube or in other container) is withdrawn for reacting in correspondence of a specific area or workstation with one or more substances to verify some physical and chemical properties.

In practice, the systems to perform analysis of samples include a work surface divided into a plurality of operating stations; on the operating stations are placed various containers for the various substances used before and during the examination to be made.

A movable arm provided with suction means is acting among the various areas of the work surface; the movable arm, before any examination, is equipped with a disposable tip or pipette-type to perform the withdrawal of the samples and/or of reagents and/or of mixtures formed on the work surface, such as to induce a certain reaction. During a possible examination procedure, the mobile arm, which is associated with its tip, picks one or more reagents/solvents and the sample to be tested, to take them on a workstation, where starts the reaction necessary for the examination, with the possible contribution of heat and/or other means. Once the various substances were moved along the work surface, the tip is separated from the movable arm and the apparatus provides for the cleaning of one or more areas that have to be re-used.

The known analysis systems, even if they allow a relative automation of analysys procedures, are not free from drawbacks, as will be explained later in this description, which will make evident the aims and the advantages of the present invention, which has the main aim of the improvement of the systems for analysis of samples. This result was achieved in accordance with the invention by adopting the idea of a system having the characteristics described in claim 1. Other features are described in the dependent claims.

A first advantage is that the system is equipped with a work surface formed by a plurality of parallel guides presenting a complementary section wich can be coupled with a corresponding seat of racks, the seat of said racks having a width multiple in respect of the section of said guide, with portions that are opposite to the corresponding profile of the same guide. This feature provides modularity, allowing the use of racks of different width without changing the work surface.

A second advantage is that the system is provided with a detection device of the rack arranged on one or more guides comprising a magnetic sensor which can detect the interaction between a magnet placed on the work surface and a corresponding metallic element placed on the rack. This feature allows to accurately and quickly detect the presence of a rack on a rail.

A third advantage is that the system is provided with a device for supporting pipettes or tips having at least two seats spaced a certain value multiple or sub-multiple of the value of the distance between two seats placed on said racks. This feature allows multiple sampling, i.e. the sampling work on multiple seats simultaneously.

A fourth advantage is that each of these racks is is provided with at least three distinct barcodes: a first code to identify the serial number and type of rack, a second code, placed on the bottom of a seat intended to support the item on the rack next to an open area that is permeable to light, to allow reading the code when the seat is not occupied, and a third code which identifies the position of each seat. This feature, combined with the reading of magnetic code described above, allows for a unique recognition of all the resources that the operator puts on the bench. Both single-level recognition of correct positioning on the floor.

A fifth advantage is that the system is provided with a pair of parallel linear guides which allow the sliding of a movable bridge leading the tips for the taking and handling of substances on the work surface. This feature allows you to ensure accuracy and provide an extremely high intrinsic simplicity.

A sixth advantage is that the system has a manifold for the washing liquid provided with valves arranged according to a star converging on a central duct outlet. In this way the washing operation of the circuit between two buffers is much faster and the chances of pollution are reduced. Unlike in other applications of a known type in which the manifolds are generally in line.

A seventh advantage is that the system, which is provided with a plurality of containers for the washing liquid or buffer and at least one collection container is also equipped with load cells to verify the filling of said containers. Furthermore, the containers can advantageously be contained in a hidden drawer, sliding along rails so as to facilitate the emptying and replenishing operations.

An eighth advantage is that the system is provided with a cassette for discharging used tips, extending over substantially an entire dimension of the work surface. This feature greatly facilitates the unloading of the tips; the handling times are optimized and the effect of overcrowding in an only point of discharge is avoided, contrary to what happens for the systems currently on the market, in which all the used tips are deposited only in one zone (usually a tank) with the need for intervention by an operator from time to time to equalize the distribution of tips in the container. In our case, the tips are distributed over an area so large as to eliminate the problem.

A further advantage is that the system is equipped with hardware and firmware based on the concept of distributed intelligence, which includes a central unit based on a microcontroller and a plurality of peripheral cards which are also equipped with microcontrollers that manage the individual work units. This type of control allows to have a microcontroller-based central unit having the correct power for the application and then peripherical cards which are also provided with microcontrollers that manage individual work units. In this way, there are several advantages as will be described later.

Every technician who works in this field will better understand these advantages and features and further advantages and features of the present invention thanks to the enclosed drawings as a practical explanation of the present invention which should not be considered in a limitative sense, wherein:

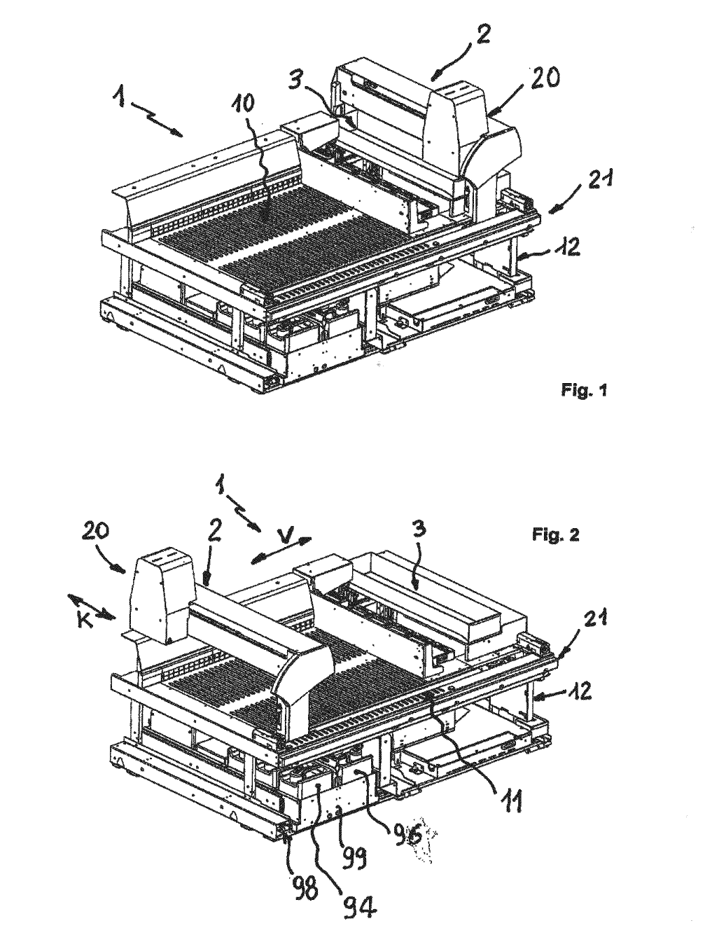

FIG. 1 is a top schematic perspective view of a system of analysis carried out according to the invention, provided with a movable bridge placed in the area for discharging the tips;

FIG. 2 is a perspective view similar to that of FIG. 1, in with the movable bridge is dsposed in a different zone or station of the work surface;

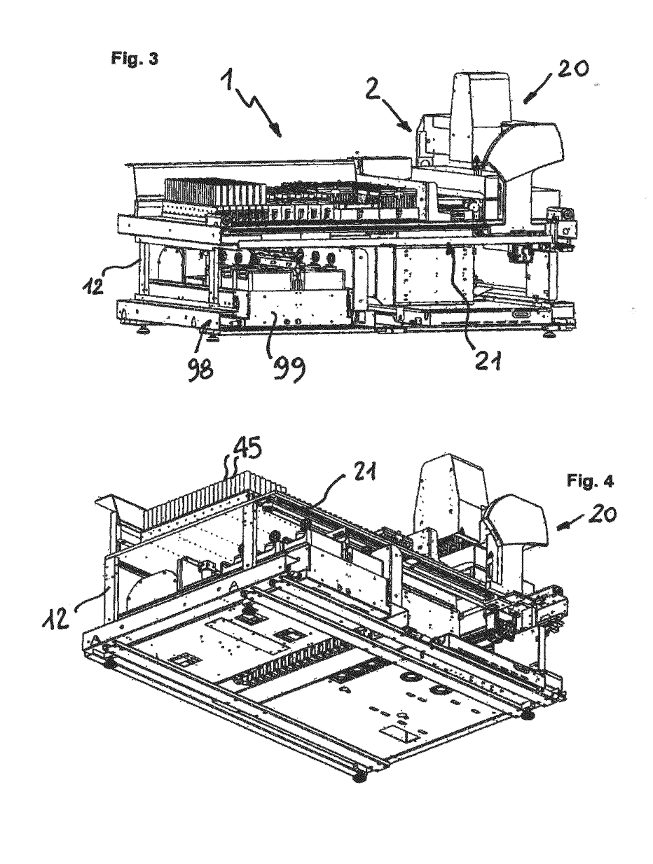

FIGS. 3, 4 are two schematic perspective views, taken from different angles, of the system of the invention; in the figures are visible, inter alia, the linear guides along which runs the movable bridge above mentioned;

FIG. 5 is a top schematic perspective view showing a particular of a device for supporting the tips, with the movable bridge placed at the front of the work surface;

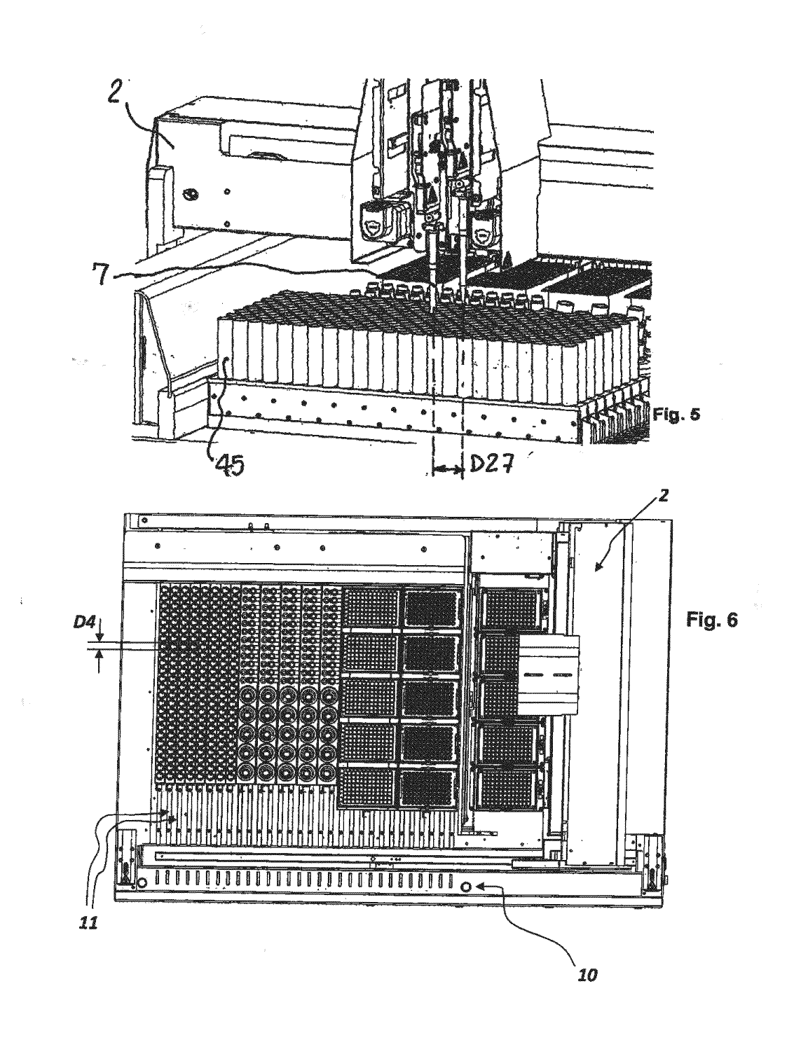

FIG. 6 is a schematic top view of the work plan;

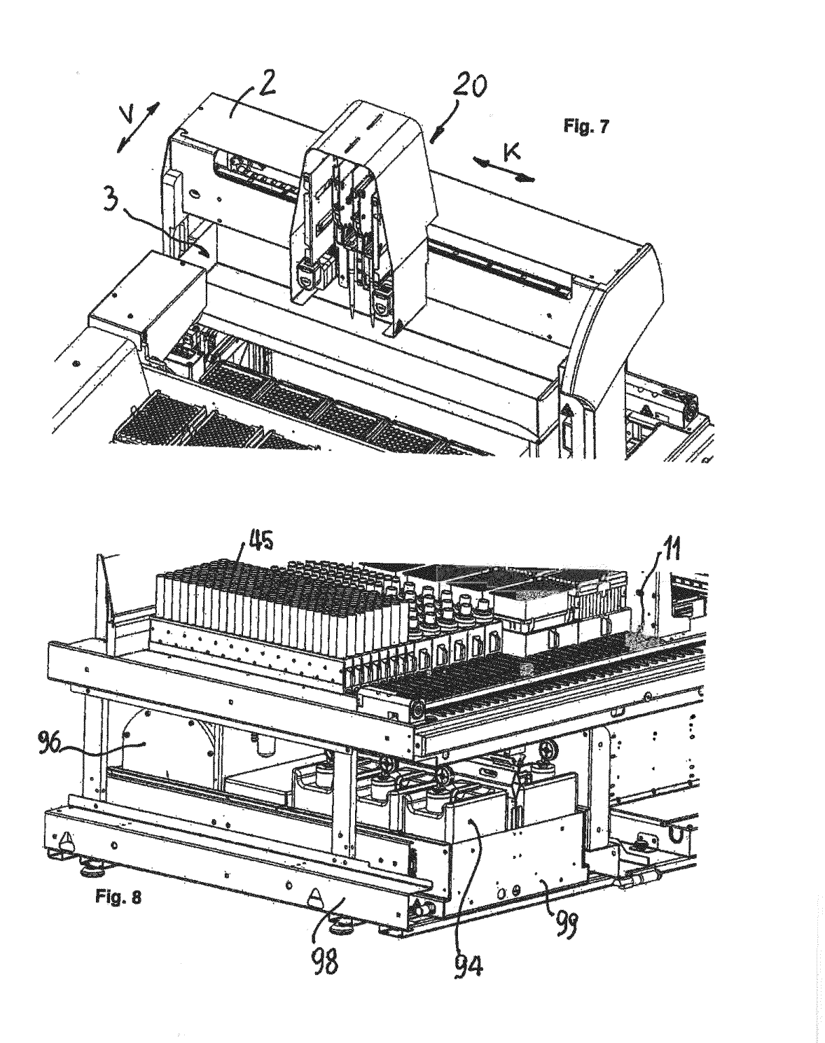

FIG. 7 is a top schematic perspective view showing another particular of the device for supporting the tips, the movable bridge being placed in the rear of the work surface, in correspondence of the container for discharging used tips;

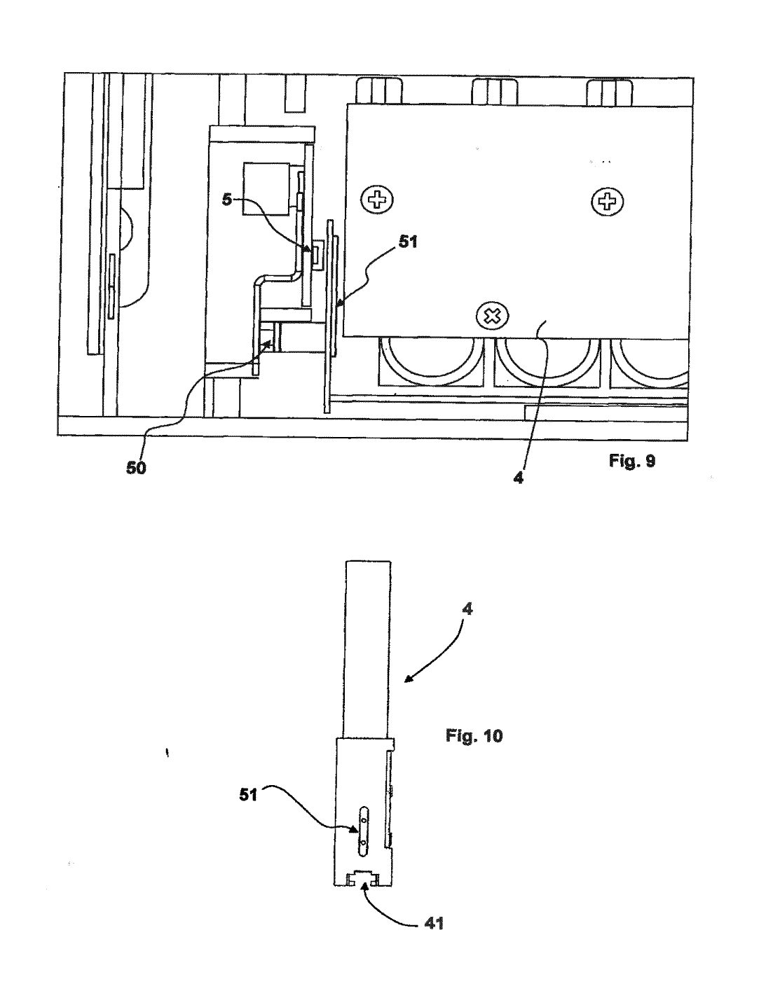

FIG. 8 is a schematic perspective view of the front part of the work surface;

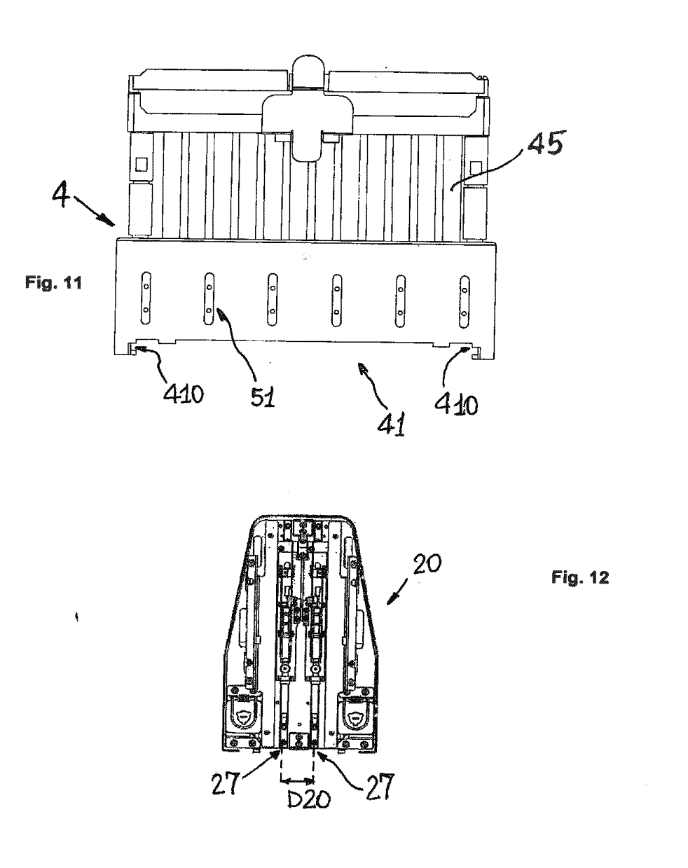

FIGS. 9, 10, 11, relate to a detection system for verify the correct positioning of the racks on the work surface and show, respectively, a schematic side view (FIG. 9) of a portion of rack associated to the system, and two rear schematic views (FIGS. 10, 11) of possible embodiments of the rack;

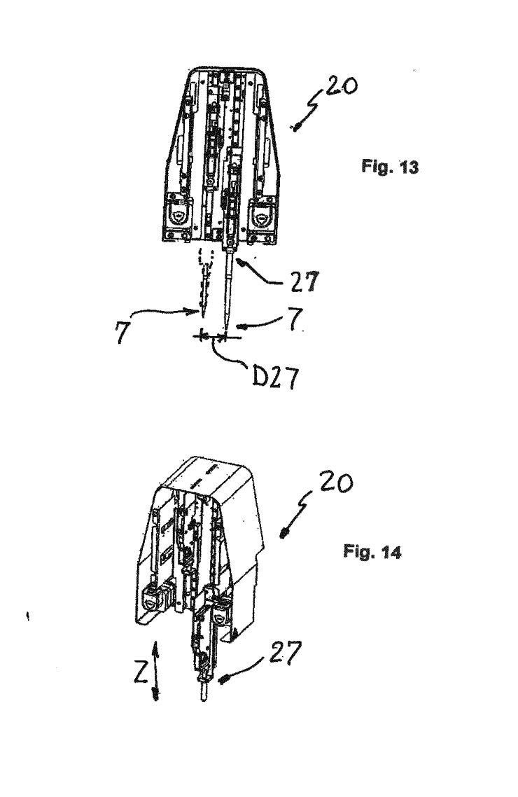

FIGS. 12, 13, 14 show the tips supporting device shown, respectively, in two frontal views (FIGS. 12, 13) and in a perspective view (FIG. 14);

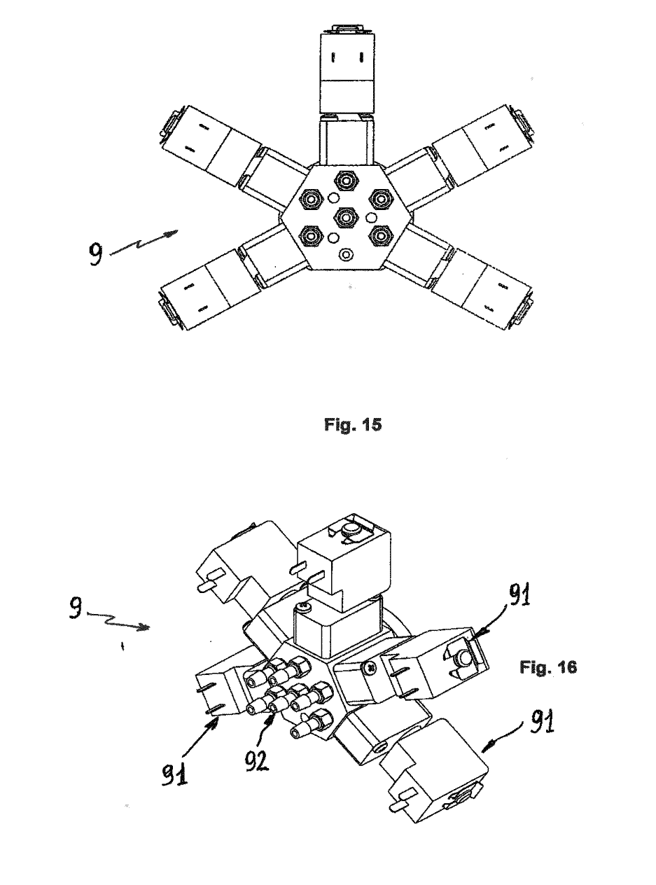

FIGS. 15, 16 relate to a possible embodiment of a collector (manifold), shown, respectively, in a frontal view (FIG. 15) and in a perspective view (FIG. 16);

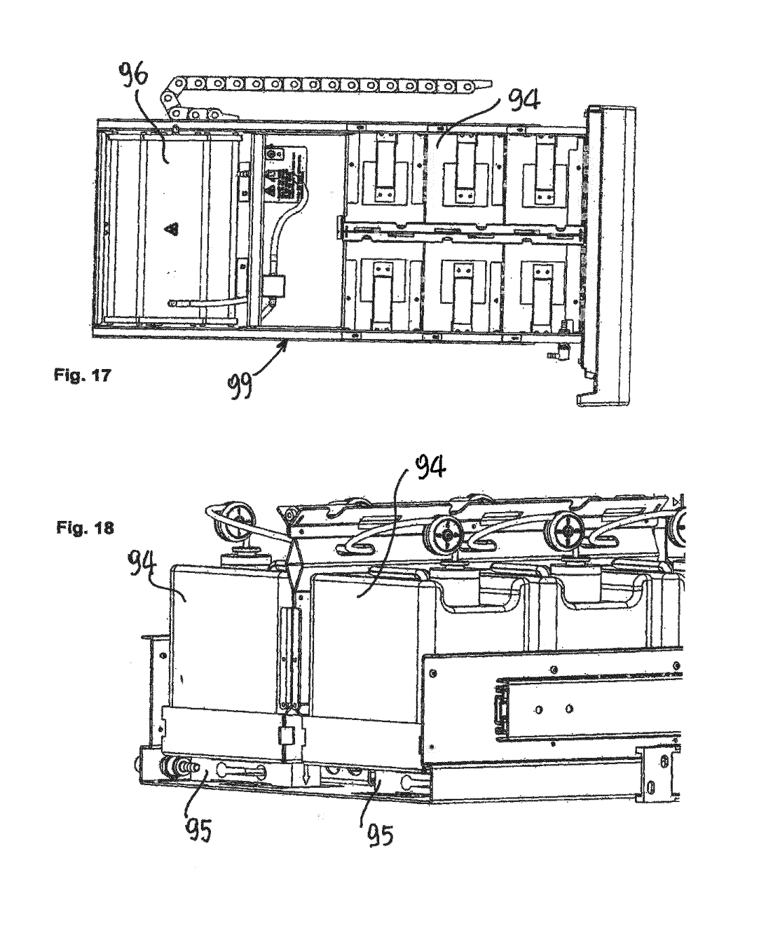

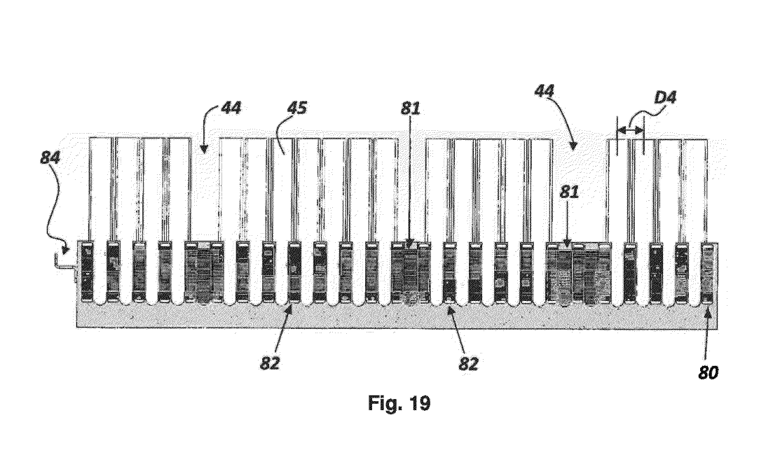

FIGS. 17, 18 relate to a possible embodiment of containers for discharge liquid, shown, respectively, in a frontal view (FIG. 17) and a partial perspective view (FIG. 18), and

FIG. 19 is a frontal view of a possible embodiment of a rack in which is visible in a detecting system in accordance with the invention;

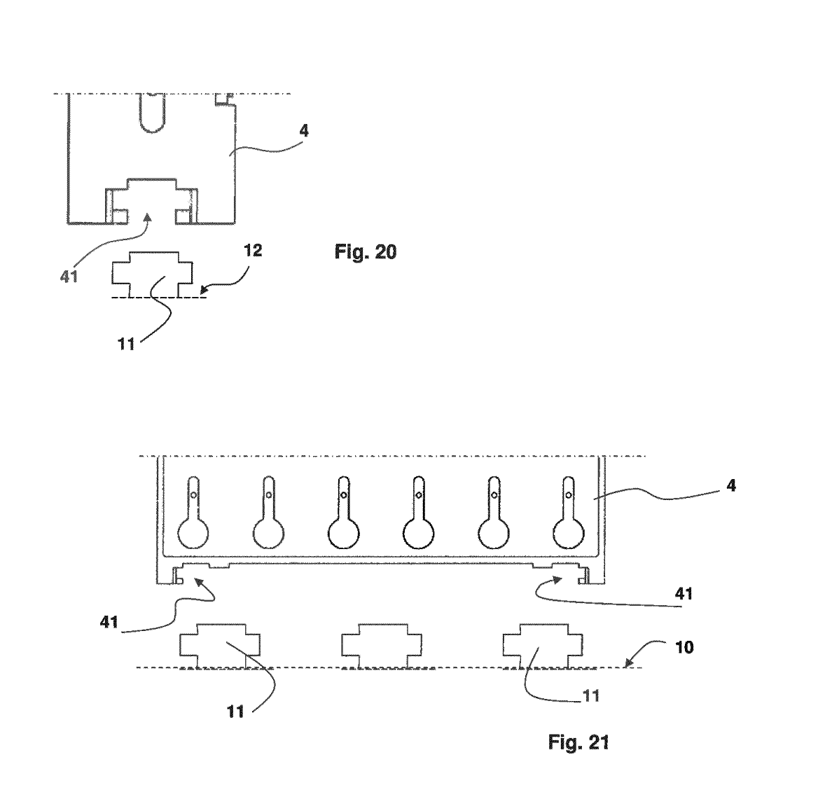

FIGS. 20, 21 are two schematic examples which show the association between the racks and the guides of the work surface.

With reference to the figures of the annexed drawings, a system 1 in accordance with the invention includes a work surface 10 on which are placed containers for the samples to be tested, tips, containers for solvents/reagents, micro-plates to perform the reactions, etc. . . .

In this description, referring to the orientation of FIGS. 1 and 2, the area disposed on the left will be indicated as frontal area and the area placed on the right (in correspondence of the container 3 intended to receive the used tips 7) will be indicated as back area.

The work surface 10, which in the example is supported by vertical legs 12, is formed by a plurality of linear guides 11 having a section which is complementary shaped in respect to a corresponding seat 41 of the racks 4 to be associated on the same surface 10. In practice, with reference to the example shown, the guide section 11 is substantially T-shaped and the racks 4 are provided with a seat 41 in which there is a cavity that can be associated with said guides 11. With the solution of the present invention, it is possible to associate racks of different sizes to the guides 11, since the seats of the different racks have a width which is a multiple of the width of the section of the guide 11 and the same seats have portions 410 that correspond to the profile of the guide. The term “different dimension” means the development of the rack in a direction orthogonal to the longitudinal development of the guide 11.

Referring to FIGS. 10 and 11, a “single” rack 4 (see FIG. 10) which can be used, for example, for supporting the samples to be tested, is provided with a seat 41 whose profile matches the profile of the guide 11; a “multiple” rack 4, as shown in FIG. 11 (which in this example has a corresponding multiplication of six single rack), has two opposing hollow portions 410 which delimit the cavity 41 in orde to slide on two profiles of the guides 11 spaced apart by six units, i.e., arranged so as to include within them five guides.

In this way, the rack can be placed randomly throughout the work surface, because all the guides 11 which form the same surface 10 are able to receive racks of different sizes.

This feature determines an advantage in respect to the state of the art that, in contrast, provides guides which are not exchangeable for the different racks. In other words, according to the present invention all the resources, in terms of any choice made—depending of the type of examination, the number of samples, the type of reagents and/or containers used, etc.—can be placed on th work surface.

FIGS. 20 and 21 show possible examples of association between the guides 11 and the racks 4. In the example of FIG. 20 the rack 4 is a “single rack” having a seat 41 that can be associated to a single guide 11. The rack 4 of FIG. 21 has a seat 41 which has a corresponding multiplication of three single rack; in this way the rack can be engaged with three guides 11.

In addition, a system 1 in accordance with the present invention is able to determine the type and number of 4 racks fitted to the worktop 10.

In the example shown the system is provided with electronic sensing devices that, in this case, are magnetic, but may also comprise optical-beam or reflective devices. The system is able to identify the type of rack placed on the rails and how many units (understood as the number of guides involved) compose the same rack. For example, the rack which supports samples for analysis can be a one-unit rack, the rack which supports reagents and controls can be a two-unit rack, such as the rack supporting the tips, and the rack which supports the dilution plates may include six units. The magnetic detection system, which will now be described, has the advantage that is not adversely affected by dust and dirt as could happen, on the contrary, for an optical system.

As shown in FIG. 9, on the frame of the apparatus that defines the system 1 is attached a magnetic sensor 5 which can recognize the interaction between a magnet 50 placed on the apparatus and a corresponding plate of iron 51 placed on the rack 4. In practice, the plate 51 extends vertically as to connect the magnet 50, disposed at the bottom, with the corresponding sensor 5, arranged at the top. Since each rack 4 provides a plate for each of the constituent units, the system is able to recognize, automatically, the width of each rack 4 on inserted on the guides 11 which form the work surface 10. In other words, the number of magnets “engaged” by the plates determines the value of the assessment determined by the system.

Another advantage of this system is that the device 20, which supports the tips 7, is capable of carrying two tips, for which there are two corresponding seats 27 spaced a certain value D27 (e.g. 36 mm) and that the sample holder rack 4 has a test tube-step D4 having a second determined value (e.g. 18 mm), said second value being related to the value D27 which is the value of the distance between the tips, and related to the value D4′ which is the value of the distance between the seats of the reaction plates (e.g. 9 mm); in this way is possible to take two samples simultaneously at a time, simultaneously treating as the step between the two pipette holders is a multiple of step between the the seats on the reaction plates. As an example, the step of the reaction plates may be equal to 9 mm on the narrow side (where there are 8 seats), the same happens for the dilution plates and tip holder boxes. This allows a reduction in time by almost 50% and a significantly reduction of the movement of the movable bridge 2 that moves the two tip holders in an optimized way.

A further advantage of the present invention is that the racks 4 to associate with the work surface 10 are all provided with three distinct bar codes, as shown in FIG. 19. On the work surface, or in correspondence of the movable bridge 2, there are suitable reading means to recognize the bar codes when the racks are associated with the work surface 10. The first code 80, placed right in the drawing, is what identifies the serial number of the rack and the type (a sequential number with a number for the type: sample holder rack, reagents racks, reagents rack for a specific reagents application, etc. . . . ); the second code 81 is placed at the bottom of the seat 44 for the test tube 45 (or other container) and has an underlying code with the position of the tube 45. The seat 44 is open on the bottom or, however, permeable to light, so that it is possible to read the code 81 when the seat 44 is not occupied by the tube 45. This will determine whether in the seat 44 there is a test tube 45 (or a bottle of reagent or whatever depending on the type of rack). The third bar code 82 identifies the position of each seat 44. The numeral reference 84 corresponds to a handle grip. In practice, once a first code 80 has been read, the system detects the serial number of the rack and its type (samples, reagents, etc. . . . ). When the second code 81 has been read, it means that in that position no object was placed; on the contrary, if the second code 81 is not read but, instead, it is read another code, this code will correspond to a specific object code that can be added to the rack; in the absence of reading (no code recognized) there may be several possibilities: the object may not have entered the bar code, the object can not be positioned correctly, the barcode is unreadable, etc. . . . : interpreting this information the system provides a signal to management software that will alert the operator. The reading of the third code 82 allows the correlation of the position along the rack to the code read at the previous seat 44. This is repeated in successive positions, i.e. for each of the 44 seats; the only code that is present only once is the first code 80, that identifies the serial number and type of rack. This feature combined with the reading of the magnetic code allows a unique recognition of all the resources that the operator puts on the work surface, regarding the single recognition and the correct positioning on the surface.

The movable bridge 2 is moved along the work surface in a direction V orthogonal to the development of the guides 11 which form the work surface 10. The device 20, which supports the tip 7, can move along the development of the movable bridge 2 in a direction K perpendicular to the movement direction of the bridge 2. The leads 7, finally, are moved vertically (Z direction) by the device 20.

Another advantage of the present invention derives from the use of two parallel linear guides 21 which allow the sliding of the movable bridge 2 that supports the two holder tips, guides that are directly attached to the work surface. In practice, there aren't differences due to the relative positioning between the guides 21 and 10 work surface. This feature allows an extremely high intrinsic accuracy and a manufacturing simplicity that the known type systems haven't.

In FIGS. 15 and 16 is shown as a possible embodiment of a manifold 9 for the washing liquid used, for example, to clean the micro-plates on which are placed the samples to react. The manifold 9 is made of plastic and it houses the valve 91 which provide buffers for the washing liquid. The peculiarity of this manifold is the fact that the valves 91 are arranged according a star, and all converge on a central outlet hole 92. In this way, the washing operation of the circuit between a buffer an the other is much faster and the chances of pollution are reduced. In other applications of a known type manifolds are generally in line. The drawings show six valves, but the valves may be more or less depending on the needs of the machine.

FIGS. 17, 18 show a tray 99 containing six cans for 94 wash buffers (which are connected to the valves 91 mentioned above) and the tank 96, which collects all the used washing liquid (waste tank). The peculiarity of this group of the system lies in the fact that it is completely hidden, since it is mounted on telescopic rails 98 (visible in FIG. 2); on the contrary, the similar equipment currently on the market are provided with tanks placed out of the apparatus or even placed on the floor. Furthermore, compared to the prior art apparatus, the level sensors with electrical components, that are immersed in the liquid, have been removed; the elimination of level sensors with electrical components determines the elimination of significant safety and maintenance problems that distinguish the known techniques for the frequency, usually at least daily, of the replacement of tanks, replacement which can produce a deterioration of the cables that connect the sensors. Instead of the level sensors, the present invention provides load cells 95 which continuously monitor the weight of residual liquid inside the tanks both for the buffers 94 and for the waste 96.

FIGS. 12-14 show the tip pick-up and release system incorporated all in the same mechanism; this allows to release the tip 7 at any position, without having to go in a fixed position as it is provided in the apparatuse currently on the market. The system is also provided with a cassette 3 for discharging exhaust tips 7 that extends throughout all the depth of the work surface 10, near the plates for analytical reaction. This optimizes the handling time and avoid the effect of overcrowding in the only point of release, as the equipment currently on the market, in which all tubes are deposited in one area (usually a tank) with the need for intervention from time to time to equalize the distribution of tips in the container. In our case, the tips are distributed over an area so large as to eliminate the problem.

Another important feature of this system is to have a hardware and firmware electronic control based on the concept of distributed intelligence, the type known as profibus (in industrial automation) or can bus (mainly in the automotive sector). This type of control includes a microcontroller-based central unit having the correct power for the application and then peripherical cards which are also provided with microcontrollers that manage individual work units. In this way, there are several advantages. It is sufficient a single cable which by means of connectors carries the signals between peripheral cards and the central unit; in this cable are also carried all supply voltages for the various connected devices. In addition, there are micro-tasks performed on the peripheral cards, the central unit sending to the peripheral units macro instructions that the same peripherical units will interpret. In practice, there are more small units where easily testable small firmwares are stored and a central firmware which sends macro-commands and receives macro-responses relating to execution of the command or to possible happened error. The central unit can be connected to a camera to be used as a web-camera for a remote monitoring of the apparatus.

In conclusion, it is possible to affirm that a system for the analysis of samples according to the present invention comprises: a work surface having a plurality of parallel guides configured for supporting a number of racks; at least a first rack and a second rack configured to support tubes or containers to be analyzed, said first rack including a first seat configured for mounting on said parallel guides and said second rack including a second seat configured for mounting on said parallel guides and having a width which is a multiple of the corresponding width of said first rack; and—a device for supporting pipettes or tips provided with a corresponding seat used for said pipettes or tips. The system is characterized in that: each of said parallel guides having a cross section which is complementarily matchable with the seat of each of said racks, said seat having a width which is a multiple of the width of said cross section of said guide and having opposing portions which correspond to the profile of said guides, so as to allow mounting on said work surface said first rack, said second rack and racks having widths which are multiple of the width of said first rack; said corresponding seats for the pipettes or tips include at least two seats and are spaced from one another such that the distance therebetween is a value multiple or sub-multiple of the value of the distance between two seats of said racks; the system is provided with a cassette mounted above said work surface for discharging used tips, said cassette extending over substantially an entire dimension of the work surface.

The control and monitoring members of the elements described above and illustrated in the attached drawings are of the type known to the skilled in the art and, therefore, were not described in further detail for simplicity.

In addition, the construction details may vary in any equivalent way as regards the shape, dimensions, disposition of elements, nature of the used material, without nevertheless departing from the scope of the adopted solution idea and thereby remaining within the limits of the protection granted to the present patent.

1. A system for the analysis of samples comprising:
a work surface having a plurality of parallel guides configured for supporting a number of racks;
at least a first rack and a second rack configured to support tubes or containers to be analyzed, said first rack including a first seat configured for mounting on said parallel guides and said second rack including a second seat configured for mounting on said parallel guides and having a width which is a multiple of the corresponding width of said first rack; and
a device for supporting pipettes or tips provided with a corresponding seat used for said pipettes or tips; wherein:
each of said parallel guides having a cross section which is complementarily matchable with the seat of each of said racks, said seat having a width which is a multiple of the width of said cross section of said guide and having opposing portions which correspond to the profile of said guides, so as to allow mounting on said work surface said first rack, said second rack and racks having widths which are multiple of the width of said first rack;
said corresponding seats for the pipettes or tips include at least two seats and are spaced from one another such that the distance therebetween is a value multiple or sub-multiple of the value of the distance between two seats of said racks; and wherein
the system is provided with a cassette mounted above said work surface for discharging used tips, said cassette extending over substantially an entire dimension of the work surface.

2. The system according to claim 1, wherein the system is provided with a sensing device for the rack arranged on one or more guides, comprising a magnetic sensor, which detects the interaction between a magnet provided on the work surface and a corresponding metallic element provided on the rack.

3. The system according to claim 1, wherein each of said racks is provided with at least three distinct barcodes: a first code configured to allow identifying a serial number and type of rack, a second code, placed on the bottom of a seat intended to support the item on the rack next to an open area that is permeable to light, to allow reading the code when the seat is not occupied, and a third code configured to identify the position of each seat.

4. The system according to claim 1, wherein the system is provided with a pair of parallel linear guides which allow the sliding of a movable bridge leading the tips for the taking and handling of substances on the work surface.

5. The system according to claim 1, wherein the system is provided with a collector for collecting washing liquid, said collector includes valves arranged as a star shape and a central outlet hole.

6. The system according to claim 1, wherein the system is provided with a plurality of containers for washing liquid or buffer and at least one collection container, and wherein the system is provided with load cells beneath said containers and being configured to monitor the weight of said washing liquid in said containers.

7. The system according to claim 6, wherein said containers are stored in a closed drawer, below said work surface, said drawer sliding along rails

8. The system according to claim 1, wherein the system includes a central unit based on a microcontroller and a plurality of peripheral cards which are also equipped with microcontrollers that manage individual work unit.

9. The system according to claim 1, wherein the system includes a movable bridge which is movable along said guides and which supports tips for the withdrawal and the handling of substances on the work surface.

10. The system according to claim 1, wherein the system is provided with hardware and firmware based on the concept of distributed intelligence, which includes a central unit based on a microcontroller and a plurality of peripheral cards which are also equipped with microcontrollers that manage individual work units.
